(19) United States
(12) Patent Application Publication
(10) Pub. No.: US 2008/0158859 A1
(43) Pub. Date: Jul. 3, 2008

(54) Flashlight with Integrated Defensive Spray Dispenser

(76) Inventors: Neil McMeekin, Columbus, OH (US); William Kirchner, Columbus, OH (US)

Correspondence Address: BUTZER & CHEN LAW, LLC, 870 HIGH STREET, SUITE 104, WORTHINGTON, OH, 43085, US

(21) Appl. No.: 11/617,655

(22) Filed: Dec. 28, 2006

(51) Int. Cl. F21V 33/00; B65D 5/66; B67D 1/07

(52) U.S. Cl. 362/96; 222/113; 222/192

(57) ABSTRACT

A mace-light (i.e., a flashlight with an integrated defensive spray dispenser) that includes a flashlight body, an attachment by which a defensive spray dispenser can be or is attached to the mace-light, a first button on the flashlight body, and a second button on the flashlight body. The first button is a light activating button that turns a light installed in the flashlight body on or off. The first button and the second button are used in combination to activate the defensive spray dispenser attached to the mace-light via the attachment. Preferably, the first button and the second button are close enough to each other so that both can be pressed using fingers of a single hand that is holding the mace-light. A two position (safe or armed) or a three position (safe, light-on armed, and light-off armed) safety switch also can be included.

### BACKGROUND OF THE INVENTION

1. Field of the Invention

This invention relates to a police-style flashlight with an integrated defensive spray dispenser.

2. Description of the Related Art

Flashlights with integrated defensive spray dispensers and/or high decibel sound alarms combine the utility of a flashlight with a non-lethal defense mechanism.

### SUMMARY OF THE INVENTION

Existing flashlights with integrated defensive spray dispensers (“mace-lights” hereinafter) are not specifically designed for the special needs of police officers, soldiers, and the like. These special needs include operability with one hand, easily operable but effective safety mechanisms, and a configuration that is both durable and unlikely to catch on clothing or a holder or holster for the mace-light.

One embodiment of the invention is a mace-light (i.e., a flashlight with an integrated defensive spray dispenser) that includes a flashlight body, an attachment by which a defensive spray dispenser can be or is attached to the mace-light, a first button on the flashlight body, and a second button on the flashlight body.

In a preferred embodiment, the attachment for the defensive spray dispenser includes a housing attached to or integrated into the flashlight body, and the dispenser is a consumable that fits in the housing. Corners on the defensive spray dispenser housing preferably are rounded The rounded corners help to prevent the mace-light from catching on clothing or a holder or holster for the mace-light. Other types of attachments, including but not limited to permanent attachments, can be used.

The first button is a light activating button that turns a light installed in the flashlight body on or off. The first button and the second button are used in combination to activate the defensive spray dispenser attached to the mace-light via the attachment. Because both buttons need to be used in combination, accidental firing of the defensive spray is unlikely.

Preferably, the first button and the second button are close enough to each other so that both can be pressed using fingers of a single hand that is holding the mace-light. As a result, the mace-light can be fully operated with just that hand. This leaves the other hand free for other operations, for example handling documents or a lethal weapon.

In some embodiments, the two buttons must be pressed in a particular manner or order in order to activate the defensive spray dispenser. In other embodiments, the first button and the second button can be pressed in any manner or order, with the defensive spray dispenser activated whenever both buttons are pressed together.

Some embodiments can also include a safety switch, further helping to prevent accidental firing of defensive spray. Alternatively, no such safety switch could be present.

In a preferred embodiment, the defensive spray dispenser is activated using a solenoid that is powered by batteries used to power the light. With this design, as long as the light works, a user can be assured that the defensive spray dispenser will work (barring malfunctions). Alternatively, other designs can be used, including but not limited to partially or purely mechanical designs.

The defensive spray dispenser used with the mace-light preferably includes a concave side that fits snuggly to the flashlight body. This design can help to store more defensive spray in a smaller size. The dispenser also preferably includes a recessed activation trigger that triggers the defensive spray. A recessed activation trigger is preferred because it deters accidental firing of the defensive spray with the dispenser is not installed in a mace-light.

This brief summary has been provided so that the nature of the invention may be understood quickly. A more complete understanding of the invention may be obtained by reference to the following description of the preferred embodiments thereof in connection with the attached drawings.

### BRIEF DESCRIPTION OF THE DRAWINGS

FIG. 1 shows a side view of one embodiment of a mace-light.

FIG. 2 shows a front view of one embodiment of a mace-light.

FIG. 3 shows a side view of one embodiment of a mace-light with a safety switch.

FIG. 4 shows a cut-away view of one embodiment of a mace-light.

FIG. 5 shows a side view of one embodiment of a mace-light with a defensive spray dispenser housing in an open position.

FIG. 6 shows a cross section of a defensive spray dispenser designed for use with one embodiment of a mace-light.

### DETAILED DESCRIPTION OF THE INVENTION

### Mace-Light

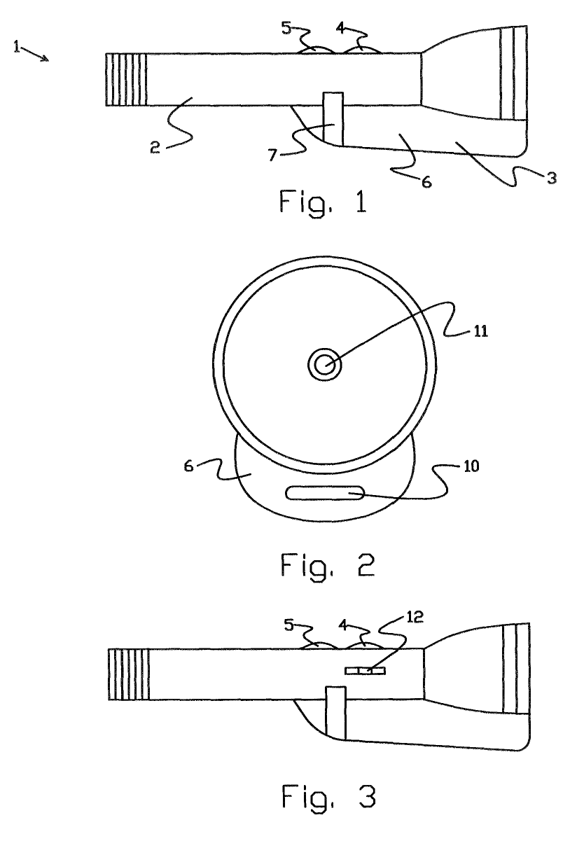

FIG. 1 shows a side view of one embodiment of a mace-light.

According to the invention, a “mace-light” is a flashlight with an integrated defensive spray dispenser. The term “defensive spray” is meant to cover any type of defensive spray, including but not limited to chemical mace, tear gas, and pepper spray. The spray optionally could include other components, for example but not limited to a dye component. (The term “mace-light” is used instead of “defense-spray light” for the sake of convenience, but should not be read as limiting the scope of the invention.)

One embodiment of the invention is a mace-light (i.e., a flashlight with an integrated defensive spray dispenser) that includes a flashlight body, an attachment by which a defensive spray dispenser can be attached to the mace-light, a first button on the flashlight body, and a second button on the flashlight body. The first button is a light activating button that turns a light installed in the flashlight body on or off. The first button and the second button are used in combination to activate the defensive spray dispenser attached to the mace-light via the attachment. Because both buttons need to be used in combination, accidental firing of the defensive spray is unlikely.

Thus, FIG. 1 shows mace-light 1 that includes flashlight body 2, attachment 3 by which a defensive spray dispenser can be attached to the mace-light, and buttons 4 and 5.

The attachment 3 in FIG. 1 includes housing 6 attached to or integrated into the flashlight body, along with strap 7 for holding the housing closed against the flashlight body. This type of attachment is preferred because it protects the defensive spray dispenser from damage and holds it very securely to the flashlight housing. However, any other type of suitably secure attachment, including but not limited to a permanent attachment, can be used.

One of buttons 4 and 5 turns a light installed in the flashlight body on or off. In this respect, the button operates as a normal flashlight button or switch.

Both buttons 4 and 5 are used in combination in the process of activating the defensive spray dispenser. Preferably, the first button and the second button are close enough to each other so that both can be pressed using fingers of a single hand that is holding the mace-light. As a result, the mace-light can be fully operated with just that hand. This leaves the other hand free for other operations, for example handling documents or a lethal weapon such as a sidearm.

This arrangement results in operation that is particularly suited for use by police officers, soldiers, and the like. For example, a police officer conducting a traffic stop at night could shine the light from a mace-light into a driver's compartment while holding the mace-light with one hand. The police officer's other hand would be free to handle documents such as a driver's license and insurance card. Then, if the person inside the vehicle initiated an improper or threatening action, the officer could use both buttons 4 and 5 to activate the defensive spray. The police officer's other hand would still be free for taking another action such as utilizing his or her sidearm, if necessary. Of course, the mace-light is not limited to use by police officers or use in such situations.

In some embodiments, the two buttons must be pressed in a particular manner or order in order to activate the defensive spray dispenser. In other embodiments, the first button and the second button can be pressed in any manner or order, with the defensive spray dispenser activated whenever both buttons are pressed together.

For example, the first button can be designed to turn the light on or off with each press and release or to turn the light on only when being pressed. Then, as long as the first button is still being pressed, the defensive spray can be activated by pressing the second button. In this arrangement, the first button operates as both a light activating button and as a safety for the defensive spray, and the second button operates as a defensive spray activating button.

As a second example, the first button can be designed to turn the light on and off with each press and release. Then, the second button can be held in preparation of using the defensive spray, which can be activated by pressing the first button again. In this arrangement, the first button operates as both a light activating button and a defensive spray activating button, and the second button operates as a safety for the defensive spray.

In some embodiments, an additional condition for activating the defensive spray can be that the light is still on, although this need not be the case. In other embodiments, activation of the defensive spray can automatically turn on the light. In still other embodiments, the light can turn on and off strictly in accordance with manipulation of one of the buttons. In yet other embodiments, both buttons could be effective to turn on the light.

As should be evident from the above discussion, the buttons can be of different functional types from each other. For example, the first button can be a type that changes state only when pressed (i.e., releasing the button does not change its state), while the second button can be a type that is only “on” while being pressed. Furthermore, one or both of the buttons can operate as a combination of these two types, for example turning the light on or off when pressed and released, but only working as a safety or defensive spray activating button when being pressed.

A logic based approach provides great flexibility in designing the functional type and interaction of the buttons. In particular, as is well known in the art of logic design, different states can be defined based on edges (i.e., when a button is pressed or released) and state (i.e., whether a button is currently being pressed or is currently not being pressed). Such logic design can be used to implement any desired set of functional type and interactions without further invention.

Other combinations and variations of button types and interaction between buttons to activate the light and the defensive spray are possible and are within the scope of the invention.

Turning to the physical design of the mace-light, the mace-light preferably is made of a suitably strong and durable material such as steel or high impact plastic. Designs along the lines of those used by Mag-Lite® are particularly well suited to the invention. However, other designs can be used.

Another physical consideration is likelihood of the mace-light catching or snagging on clothing or a holder or holster for the mace-light. To reduce the possibility of such catching or snagging, square corners on the defensive spray dispenser housing preferably are rounded. This is illustrated by the rounded corners in FIG. 1. However, designs with square corners also can be used.

FIG. 2 shows a front view of one embodiment of a mace-light. Again, in this figure, the bottom corners of defensive spray dispenser housing 6 are rounded to help prevent catching or snagging. The housing also includes opening 10 for the defensive spray to exit the housing. The opening preferably is configured to provide a suitably aimed pattern of spray that points in a same direction as light 111 installed in the mace-light. Openings with different shapes from the one shown in FIG. 2 can be used.

FIG. 3 shows a side view of one embodiment of a mace-light with safety switch 12. Some embodiments of the invention include this additional safety switch to further help prevent accidental firing of the defensive spray.

In preferred versions of embodiments with safety switch 12, the safety switch acts as an “override” for preventing activation of the defensive spray. Thus, if the safety switch is in a “safe” position, the defensive spray cannot be activated by the buttons. If the safety switch is in an “armed” position, the defensive spray can be activated by the buttons.

Safety switch 12 can have multiple armed positions. For example, the safety switch could have a “light on armed” and “light switched armed” positions. When the safety switch is in the light-on armed position, the light is on regardless of if the first button is pressed. When the safety switch is in a light-switched armed position, the light is controlled by one of the buttons. In either armed position, the buttons can be used in combination to activate the defensive spray dispenser.

Safety switch 12 preferably is located in relation to buttons 4 and 5 so that it also can be manipulated with a hand that is holding the mace-light, for example with the thumb. FIG. 3 shows such a configuration.

Other and different types and locations of safeties can be used without departing from the invention. Alternatively, no additional safety needs to be present in addition to buttons 4 and 5.

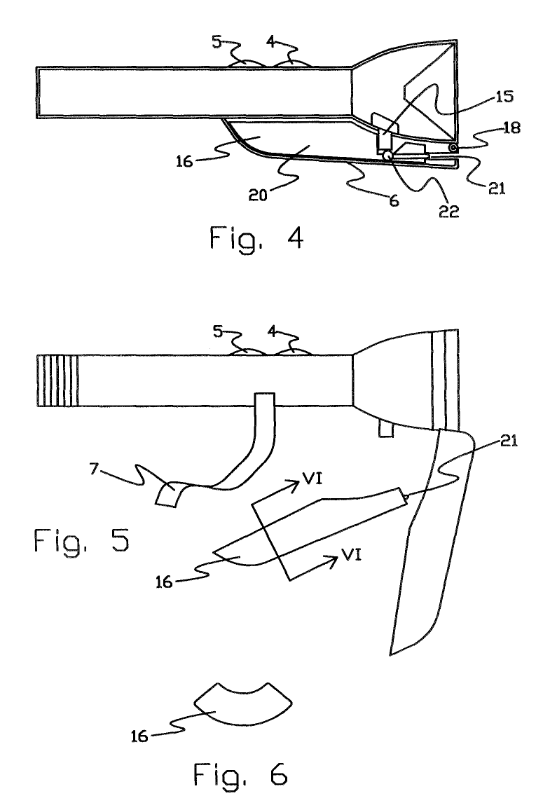

FIG. 4 shows a cut-away view of one embodiment of a mace-light. This view shows solenoid 15 that is used in a preferred embodiment of the invention to activate defensive spray dispenser 16 installed in housing 6. Use of an electrically operated solenoid facilitates implementation of a logic-based (i.e., electrical) design for operation of buttons 4 and 5. Preferably, the solenoid is powered by batteries used to power the light. With this design, as long as the light works, a user can be assured that the defensive spray dispenser will work (barring malfunctions). Alternatively, other designs can be used, including but not limited to partially or purely mechanical designs.

In some embodiments, housing 6 can be attached to flashlight body 2 with a hinge such as hinge 18 as shown in FIG. 4. FIG. 5 shows a side view of such an embodiment in an open position. This arrangement is preferred because it facilitates easy insertion of defensive spray dispenser 16 into housing 6. Then, the housing can be swung shut and secured, for example using strap 7 shown in FIGS. 1 and 5. As noted above, the invention is not limited to this arrangement or even to using a housing for attachment of the defensive spray dispenser.

### Defensive Spray Dispenser

FIGS. 4 to 6 show details of one embodiment of a defensive spray dispenser that can be used with some embodiments of the invention. This embodiment is a consumable that can be replaced by a user. In the figures, dispenser 16 includes container 20 that stores defensive spray under pressure. As shown in the cross-section in FIG. 6, the container includes a concave side that fits snuggly to the flashlight body. This design can help to store more defensive spray in a smaller size.

The dispenser also include nozzle or opening 21 that fits to a conduit to opening 10 for the defensive spray to exit housing 6. As shown in FIG. 4, dispenser 16 also includes recessed activation trigger 22 that triggers the defensive spray to exit the container though the nozzle or the opening. A recessed activation trigger is preferred because it deters accidental firing of the defensive spray with the dispenser is not installed in a mace-light.

Other styles and designs of defensive spray dispensers can be used with the invention depending on the design of the mace-light. For example, the defensive spray dispenser could be permanently attached to the mace-light. In other words, the dispenser could be a part of the mace-light and not a consumable.

### ALTERNATIVE EMBODIMENTS

The invention is in no way limited to the specifics of any particular embodiments and examples disclosed herein. For example, the terms “preferably,” “preferred embodiment,” “one embodiment,” “this embodiment,” “alternative embodiment,” “alternatively” and the like denote features that are preferable but not essential to include in embodiments of the invention. Many other variations are possible which remain within the content, scope and spirit of the invention, and these variations would become clear to those skilled in the art after perusal of this application.

What is claimed is:

1. A mace-light, comprising:
a flashlight body;
an attachment by which a defensive spray dispenser can be or is attached to the mace-light;
a first button on the flashlight body; and
a second button on the flashlight body;
wherein the first button is a light activating button that turns a light installed in the flashlight body on or off; and
wherein the first button and the second button are used in combination to activate the defensive spray dispenser attached to the mace-light via the attachment.

2. A mace-light as in claim 1, wherein the attachment further comprises a housing attached to or integrated into the flashlight body, and the defensive spray dispenser is a consumable that fits in the housing.

3. A mace-light as in claim 2, wherein square corners on the defensive spray dispenser housing are rounded.

4. A mace-light as in claim 1, wherein the attachment is a permanent attachment.

5. A mace-light as in claim 1, wherein the first button and the second button are close enough to each other so that both can be pressed using fingers of a single hand that is holding the mace-light.

6. A mace-light as in claim 1, wherein the first button and the second button must be pressed in a particular manner or order in order to activate the defensive spray dispenser.

7. A mace-light as in claim 1, further comprising a safety switch, wherein when the safety switch is in a safe position, the defensive spray dispenser cannot be activated.

8. A mace-light as in claim 7, wherein when the safety switch is in an armed position, the first button and the second button can be used in combination to activate the defensive spray dispenser.

9. A mace-light as in claim 7, wherein
when the safety switch is in a light-on armed position, the light is on regardless of if the first button is pressed;
when the safety switch is in a light-switched armed position, the light is controlled by the first button; and
when the safety switch is in the light-on armed position or the light-switched armed position, the first button and the second button can be used in combination to activate the defensive spray dispenser.

10. A mace-light as in claim 1, wherein the defensive spray dispenser is activated using a solenoid.

11. A mace-light as in claim 10, wherein the solenoid is powered by batteries used to power the light.

12. A mace-light as in claim 1, further comprising the defensive spray dispenser.

13. A mace-light as in claim 12, wherein the defensive spray dispenser includes a concave side that fits snuggly to the flashlight body.

14. A defensive spray dispenser designed to be attached to a mace-light, the defensive spray dispenser comprising:
a container that stores defensive spray under pressure, with the container including a concave side;
a nozzle or an opening for a nozzle; and
a recessed activation trigger that triggers the defensive spray to exit the container though the nozzle or the opening.

15. A method of using a mace-light, the mace-light including a flashlight body, an attachment by which a defensive spray dispenser can be or is attached to the mace-light, a first button on the flashlight body, and a second button on the flashlight body, the method comprising the steps of:
attaching a defensive spray dispenser to the mace-light via the attachment;
using the first button to turn a light installed in the flashlight body on or off; and
using the first button and the second button in combination to activate the defensive spray dispenser.

16. A method as in claim 15, wherein the first button and the second button are close enough to each other so that both can be pressed using fingers of a single hand that is holding the mace-light.

17. A method as in claim 15, wherein the first button and the second button must be pressed in a particular manner or order in order to activate the defensive spray dispenser.

18. A method as in claim 15, wherein the defensive spray light further comprises a safety switch, and further comprising the step of putting the safety switch in a safe position so that the defensive spray dispenser cannot be activated.

19. A method as in claim 18, further comprising the step of putting the safety switch in an armed position so that pressing the first button and the second button in combination activates the defensive spray dispenser.

20. A method as in claim 18, further comprising the step of:
putting the safety switch in a light-on armed position so that the light is on regardless of if the first button is pressed; or
putting the safety switch in a light-switched armed position so that the light is controlled by the first button;
wherein when the safety switch is in the light-on armed position or the light-switched armed position, the first button and the second button can be used in combination to activate the defensive spray dispenser.
